(19) United States
(12) Patent Application Publication
(10) Pub. No.: US 2008/0258968 A1
(43) Pub. Date: Oct. 23, 2008

(54) Salvage System for Life Jacket

(76) Inventor: Jung Sun Kim, Seoul (KR)

Correspondence Address: SCHMEISER OLSEN & WATTS, 18 E UNIVERSITY DRIVE, SUITE # 101, MESA, AZ, 85201, US

(21) Appl. No.: 11/911,102

(22) PCT Filed: Apr. 5, 2006
(86) PCT No.: PCT/KR06/01254

§ 371 Date: Oct. 9, 2007

(30) Foreign Application Priority Data
Apr. 11, 2005 (KR) 10-2005-0029963

(51) Int. Cl. G01S 5/02; B63C 9/08

(52) U.S. Cl. 342/357.07; 441/88; 441/89; 342/357.13

(57) ABSTRACT

The present invention relates to a salvage system for a life jacket capable of enabling quick rescue of a victim by quickly finding a victim wearing the life jacket using an artificial satellite and displaying an electronic map provided with the position of the victim and the image of the victim on a screen in real time, when a marine accident or an aircraft accident occurs, and more specifically, to the life jacket, with a marine position tracking terminal attached thereto, which transmits and receives radio signals to and from a GPS satellite and a relay satellite to track the position of the victim, and allowing greater buoyancy to be generated in the head and the chest regions on the surface of the water, when wearing it. A salvage system for a life jacket according to the present invention comprises: a life jacket; a marine position tracking terminal, attached to the life jacket, which transmits a rescue signal and an inherent ID stored in a microcomputer to a plurality of GPS satellites via a rescue signal transmitter; a relay satellite receiving the signal from the marine position tracking terminal and the GPS satellites to calculate a coordinate position of a victim wearing the life jacket and provide it to an integrated geographic information system (GIS), and monitor the image of the victim using the calculated coordinate position; and a central control center receiving information on an electronic map provided with the coordinate position of the victim and the monitored image of the victim from the relay satellite and displaying them on a status screen in real time, thereby enabling follow-up measures for early rescue of the victim.

### TECHNICAL FIELD

The present invention relates to a salvage system for a life jacket capable of enabling quick rescue of a victim by quickly finding a victim wearing the life jacket using an artificial satellite and displaying an electronic map provided with the position of the victim and the image of the victim on a screen in real time, when a marine accident or an aircraft accident occurs, and more specifically, to a life jacket, with a marine position tracking terminal attached thereto, which transmits and receives radio signals to and from a GPS satellite and a relay satellite to track the position of the victim, and allowing greater buoyancy to be generated in the head and the chest regions on the surface of the water, when wearing it.

### BACKGROUND ART

In general, the life jacket, which has excellent buoyancy, excellent wear-ability, and any other functionality, has been used to prevent a person from drowning in an accident, when persons are involved in water based leisure activities, such as at a river, a lake, a sea, etc. However, since it frequently occurs that it takes from several hours to several days to rescue a victim when a marine accident occurs, the life jacket having only the same functions has been insufficient. In other words, a main cause of the death of a person involved in an accident is from cold, due to rapidly dropping body temperature, or from exhaustion, and the like, in the case of not accurately knowing an accident location when a marine accident occurs in a wide area, such as the sea, river, etc., or the case of taking a long time to rescue a victim when the marine accident occurs at night. Therefore, it is necessary to shorten rescue time as much as possible and accurately identify a current situation of a victim. To this end, it is necessary to first locate the position of a victim quickly and accurately.

As prior arts relating to tracking a position of a victim, there are Korean U.M. Registration Publication No. 20-0186292 (registered on Apr. 7, 2000; hereinafter, referred to as the prior art 1), which discloses “Radio Rescue Signal Transmitter”; and Korean Patent Publication No. 10-0378580 (registered on Mar. 20, 2003; hereinafter, referred to as the prior art 2), which discloses “System for Identifying Existence and Position of Victim” and so on.

### DISCLOSURE OF INVENTION

### Technical Problem

In the prior art 1, a life jacket has a radio rescue signal transmitter attached for quickly finding the position of a victim, however, it has a limitation in a position accuracy and a tracking range. That is, since an accident location cannot accurately be identified in a wide sea and a victim can move further away from the accident location by ocean currents, etc., it is difficult for the rescue signal transmitter, in a conventional analog manner, to accurately identify the position of a victim. Further, the rescue signal transmitter does not provide any information about an emergency situation and has a limitation in a tracking range. In the prior art 2, the radio terminal identifies the position of a victim using signals supplied from a plurality of GPS satellites and transmits it to a communication satellite, wherein while the GPS satellite transmits the signals and the communication satellite receives an accurate coordinate position of a victim, a victim drifts due to ocean currents, resulting in that it is difficult for the radio rescue signal transmitter to transmit the accurate coordinate position of a victim. Further, the prior art 2 does not comprise a means capable of identifying a current situation of a victim.

In addition, in case of a marine accident, it is important for a victim not to fall unconscious by maintaining an adequate body temperature and taking a posture lying on his back (a skyward facing posture) to reduce his strength consumption, until he is rescued. Also, since the victim may become face down due to losing consciousness, he may die for suffocation, therefore it is important to keep him in a safe posture. To this end, it is required that the buoyancy be different at different parts of the life jacket.

As the prior arts making buoyancy at different parts of the life jacket different, as above, there are Korean Patent Laid-Open No. 2003-87848(published on Nov. 15, 2003; hereinafter, referred to as the prior art 3), which discloses “Life Jacket” and so on.

The prior art 3 relates to a life jacket of which urethane resin or an air inflating type of buoyant material is thickly formed in order to make the buoyancy of the upper portions of the chest and back larger than that of the lower portions thereof so that its wearer floats vertically in water.

However, in case that a person wears a general life jacket, since he can naturally keep a vertical posture in water, the life jacket according to the prior art 3 has little difference from other life jackets.

### Technical Solution

The present invention is proposed to solve the related problems, and it is an object of the present invention to quickly rescue a victim wearing a life jacket by accurately identifying the position of the victim and identifying the current situation of the victim through an image in real time, by transmitting a rescue signal from a marine position tracking terminal to a GPS satellite and a relay satellite, allowing the relay satellite to receive the signals from the GPS satellite for directly calculating the coordinate position of the victim and providing it to a geographic information system, and transmitting the image of the victim through a satellite DMB using the calculated coordinate position, wherein the transmission coverage of the rescue signal is global.

It is other object of the present invention to minimize victim's strength consumption and to prevent the victim's facial region from being dipped under water, by making buoyancy at different parts of the life jacket different to keep the victim in a safe posture.

### ADVANTAGEOUS EFFECTS

A salvage system for a life jacket according to the present invention can obtain an accurate coordinate position of a victim by transmitting a rescue signal in a digital form from a marine position tracking terminal attached to a life jacket to a relay satellite and calculating the coordinate position of the victim in the relay satellite, and transmit an accurate position and a current situation of the victim in real time by providing the coordinate position of the victim to an geographic information system and transmitting the image of the victim from the relay satellite through a satellite DMB using the calculated coordinate position,

Also, a life jacket according to the present invention can be conserved for a long time since its outer cover is made of a fabric having an anti-fungus function and can keep high buoyancy while reducing its volume and weight since its inner cover is made of low density polystyrene. In particular, an inner cover of a front plate of a head part and a body part of the life jacket is made of many more folds of low density polystyrene foam resin than other parts thereof so as to generate larger buoyancy, resulting in that it prevents unnecessary strength consumption of a victim wearing the life jacket and enhances the safety of the victim by not allowing the face region of the victim wearing the life jacket to contact with water, even in case of losing consciousness.

Also, the life jacket is attached with a light-emitting means, such as a LDP light-emitting device, a light-emitting tape, etc., so as to easily find the victim wearing the life jacket, even at night.

There has been described a salvage system for a life jacket having a specific shape and structure as in above description with respect to the present invention, however, changes and modifications thereof might be made by those skilled in the art and should be construed as being within the scope thereof.

### BRIEF DESCRIPTION OF THE DRAWINGS

FIG. 1 is a schematic block diagram showing a system according to one embodiment of the present invention;

FIG. 2 is a front view showing a life jacket according to one embodiment of the present invention;

FIG. 3 is a rear view showing a life jacket according to one embodiment of the present invention; and

FIG. 4 is an inner view showing a life jacket according to one embodiment of the present invention.

### DESCRIPTIONS FOR KEY ELEMENTS IN THE DRAWINGS

1: GPS satellite 2: relay satellite
3: marine position tracking terminal
4: central control center 5: rescue party
10: head part 20: body part
21: front plate 22: rear plate
23: support belt 32: microcomputer
33: rescue signal transmitter 40: night light emitting means

### BEST MODE FOR CARRYING OUT THE INVENTION

A salvage system for a life jacket according to the present invention comprises: a life jacket; a marine position tracking terminal attached to the life jacket, which transmits a rescue signal and an inherent ID stored in a microcomputer to a plurality of GPS satellites via a rescue signal transmitter; a relay satellite receiving the signal from the marine position tracking terminal and the GPS satellites to calculate a coordinate position of a victim wearing the life jacket and provide it to an integrated geographic information system (GIS), and monitor the image of the victim using the calculated coordinate position; and a central control center receiving information on an electronic map provided with the coordinate position of the victim and the monitored image of the victim from the relay satellite and displaying them on a status screen in real time, thereby enabling follow-up measures for early rescue of the victim.

In particular, the life jacket comprises; a body part having a front plate contacting with the chest or the abdomen and a rear plate contacting with the back; and a head part being removable from the body part to support the head, wherein larger buoyancy is generated in the head part and the front plate of the body part.

### MODE FOR THE INVENTION

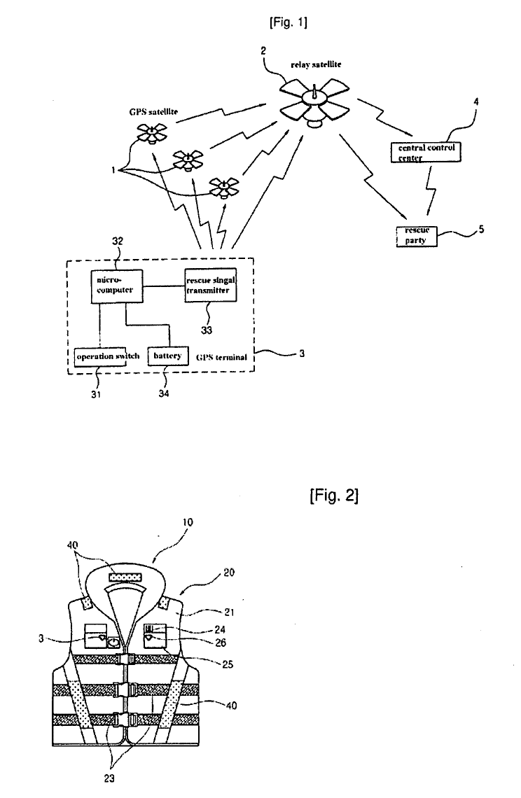

FIG. 1 is a schematic block diagram showing a system according to one embodiment of the present invention; and FIG. 2 to FIG. 4 are a front view, a rear view, and inner views showing a life jacket, with a marine position tracking terminal attached, according to the present invention.

First, the life jacket, with a marine position tracking attached, terminal according to the present invention will be described with reference to FIG. 2 to FIG. 4.

The life jacket, with the marine position tracking terminal 3 attached, according to the present invention is comprised of a body part 20 having a front plate 21 and a rear plate 22, a head part 10, a support belt 23, a night light emitting means 40, wherein the marine position tracking terminal 3 is attached to the front plate 21. In describing the detailed description of the present invention, the description of the same contents as the life jacket in the prior arts will be omitted.

Preferably, the front plate 21 is provided with two or three rows of the support belts 23 to tightly hold the life jacket on the body of a victim. Also, as shown in FIG. 4, the lower portion inside of the body part 20 is provided with the support belt 23 supporting a leg so that the life jacket can t lift over the body of the wearer. Further, the connection of the support belt 23 is preferably made by the couple of a female and male buckle formed at the ends of thereof, for convenience and safety.

The head part 10 generates larger buoyancy in the head of the wearer to protect the head region, wherein the head part is formed in a half-moon shape to wrap the neck and head of the wearer and is removable from the body part 20 of the life jacket. For reference, the removing method can be made by a zipper.

Preferably, the shoulder portion of the body part 20 of the life jacket is thinly made, leaving a gap at a region bordering with a shoulder region of the wearer between the front plate 21 and the rear plate 22, so as to allow for mobility of the wearer. Further, in case of the life jacket for a child, it is preferable to differentiate the life jacket for an adult by inserting a mark 24 indicating a child on the upper portion of the front plate 21 of the body part 20.

The body part 20 and the head part 10 are configured of outer and an inner covers.

The outer cover is a portion exposed to the outside. The outer cover is made of a fabric having an anti-fungus function to prevent the life jacket being contaminated by mold and microorganism, etc., thereby making it possible to conserve the life jacket for a long time.

The inner cover is made of low density polystyrene foam resin and is enclosed by the outer cover, wherein several folds of the inner cover are formed at important points of the life jacket. The low density polystyrene foam resin is light, and has excellent buoyancy and excellent durability. When sewing the inner cover, it will be cut out, considering the operation characteristic of the wearer, i.e., the operation convenience of the wearer and durability. Preferably, the inner cover is made of about forty folds to help maintain the body temperature of the wearer. However, the inner cover of the head part 10 is cut out in a half-moon shape to generate larger buoyancy and protect the head region, and is made of the folded low density polystyrene of 100 g or more to sufficiently support the neck and the head regions.

Also, the low density polystyrene foam resin forming the inner cover is preferably made of about forty to forty five folds for the front plate 21 of the body part 20 (in particular, the chest portion) and about thirty five to forty folds for the rear plate 22 so that larger buoyancy is generated in the chest region of the wearer. The reason why buoyancy is different is that the wearer floats in a lying position, not in a vertical position so that the victim reduces his strength consumption and does not lose consciousness, and even in the case of losing consciousness, the head of the wearer is naturally supported on the head part 10 of the life jacket to prevent the facial region of the wearer from contacting the surface of the water so that the safety of the wearer is assured.

The night light emitting means 40 is a means for easily identifying the victim at night. A flash is an efficient means in terms of brightness and identification distance, etc., as a mean for informing the position of the victim at night, however, it has constraints in that the flash is sporadic and short in duration as well as the victim seldom carries it.

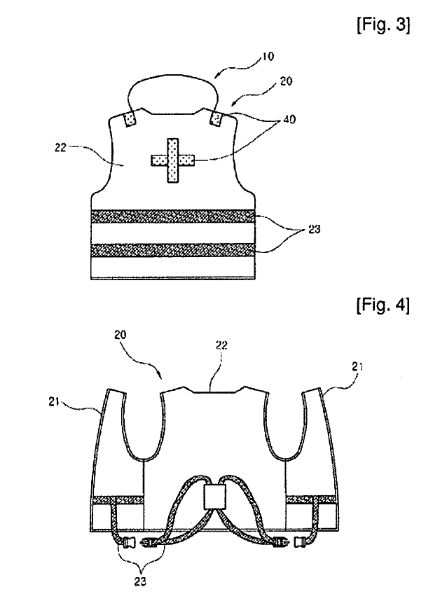

Therefore, another night light emitting means 40 is needed. In FIG. 2 and FIG. 3, there are shown light emitting tapes 40 attached to several places of the body part 20 and the head part 10, as a night light emitting means 40. The light emitting tape 40 does not emit light during the daytime, but emits light at night as well as emits a large amount of light when absorbing a small amount of light to allow for identification of the victim at a long distance. Also, although not shown in the drawings, it is possible for the victim to emit light from the light emitting lamp by operating the switch of a LDP light emitting device attached to the head part 10 or the chest part of the front plate 21, wherein the LDP light emitting device is comprised of a battery, a light emitting lamp, and a switch. Preferably, the LDP light emitting device coexists with the light emitting tape 40.

For reference, reference numerals 25 and 26 not described are a pocket, and a D ring on which a whistle, etc., can be hanged.

A salvage system for a life jacket according to the present invention will now be described with reference to FIG. 1.

Referring to FIG. 1 and FIG. 2, it comprises a marine position tracking terminal 3 attached to a life jacket, GPS satellites 1, a relay satellite 2, a central control center 4, and a rescue party 5.

When the operation switch 31 of the marine position tracking terminal 3 is ON, the marine position tracking terminal amplifies and outputs via a rescue signal transmitter rescue signals (for example, SOS, MAY DAY) and an inherent ID of a victim (an inherent number of the terminal 3) pre-stored in a microcomputer and then transmits them to a plurality of GPS satellites and a relay satellite in digital signal form. For reference, the microcomputer 32 preferably controls to transmit the rescue signals periodically to reduce the power consumption of the battery 34.

The marine position tracking terminal 3 is a device, which is formed in a chip made of a thin plate of 1 mm or less and operated by the battery. Since the marine position tracking terminal 3 is in an ON or OFF state by the simple operation of the victim, only in a state of emergency, its battery 34 may be considered to be semi-permanent. A fabric for a life jacket is waterproof with PU coating so that the life jacket can withstand water pressure on the order of 10,000 mm. Further, the components included in the life jacket have good durability and corrosion resistance capable of resisting corrosion caused by contacting with water. The marine position tracking terminal 3 will be attached to the head part 10 or the front plate 21 of the body part 20 (in particular, the chest region and the shoulder region) of the life jacket.

The relay satellite 2 uses the rescue signals received from the marine position tracking terminal 3 and the rescue signals received from the GPS satellites 1 receiving the signals from the marine position tracking terminal 3 to calculate the coordinate position of the victim wearing the life jacket attached with the marine position tracking terminal 3, provide the calculated coordinate position of the victim to an integrated geographic information system (GIS) and transmit it to the central control center, and monitor the image of the victim through a satellite DMB (Digital Multimedia Broadcast) using the calculated coordinate and transmit it to the central control center. Of course, the relay satellite also transmits the inherent ID of the victim.

The central control center 4 uses the information received from the relay satellite 2 to display the position of the victim on an electronic map and the image of the victim on a status screen in real time, thereby enabling follow-up measures for early rescue of the victim. Also, although not shown in the drawings, the central control center 4 transmits the information on the victim (the rescue signal, the coordinate position of the victim, the electronic map displaying the position of the victim, the image of the victim, the inherent ID of the victim) to an internet, a cellular phone capable of displaying images, a base station, via wired or wireless communication networks using a multi-functional trunked radio system (TRS) in conjunction with an ubiquitous computer environment. Further, since the central control center 4 is connected with an integrated coastal management information system of a national geographic information system, which is incorporated with 3.5 generation mobile communication technology capable of transmitting data at high speed and has an electronic map of the world, it is possible for the central control center to display the position of the victim on the electronic map, when receiving only the coordinate position of the victim from the relay satellite 2.

The rescue party indicates 119, a rescue aircraft, a rescue ship, etc. The rescue party receives the information on the victim (the electronic map displaying the position of the victim, and the image of the victim, etc.) from the central control center or directly receives the information on the victim from the relay satellite if it has a satellite signal receiver, such that it can carry out appropriate action for rescuing the victim.

### INDUSTRIAL APPLICABILITY

In accordance with the present invention, there is provided a salvage system for a life jacket capable of enabling quick rescue of a victim by quickly finding a victim wearing the life jacket using an artificial satellite and displaying an electronic map provided with the position of the victim and the image of the victim on a screen in real time, when a marine accident or an aircraft accident occurs, and more specifically, to a life jacket, with a marine position tracking terminal attached thereto, which transmits and receives radio signals to and from a GPS satellite and a relay satellite to track the position of the victim, and allowing greater buoyancy to be generated in the head and the chest regions on the surface of the water, when wearing it.

1. A salvage system for a life jacket comprising: a life jacket; a marine position tracking terminal, attached to the life jacket, which transmits a rescue signal and an inherent ID stored in a microcomputer to a plurality of GPS satellites via a rescue signal transmitter; a relay satellite receiving the signal from the marine position tracking terminal and the GPS satellites to calculate a coordinate position of a victim wearing the life jacket and provide it to an integrated geographic information system (GIS), and monitor the image of the victim using the calculated coordinate position; and a central control center receiving information on an electronic map provided with the coordinate position of the victim and the monitored image of the victim from the relay satellite and displaying them on a status screen in real time, thereby enabling follow-up measures for early rescue of the victim.

2. The salvage system as claimed in claim 1, further comprising a rescue party carrying out action for rescuing the victim by receiving the information on an electronic map system provided with the coordinate position of the victim and the monitored image of the victim from the central control center or the relay satellite and displaying them on a screen.

3. The salvage system as claimed in claim 1, wherein the life jacket comprises: a body part having a front plate contacting with the chest or the abdomen and a rear plate contacting with the back; and a head part being removable from the body part to support the head, wherein larger buoyancy is generated in the head part and the front plate of the body part.

4. The salvage system as claimed in claim 2, wherein the life jacket comprises: a body part having a front plate contacting with the chest or the abdomen and a rear plate contacting with the back; and a head part being removable from the body part to support the head, wherein larger buoyancy is generated in the head part and the front plate of the body part.

5. The salvage system as claimed in claim 3, wherein the body part and the head part 10 are configured of an outer cover and an inner cover, the outer cover is made of a fabric having an anti-fungus function, and the inner cover is made of low density polystyrene.

6. The salvage system as claimed in claim 4, wherein the low density polystyrene forming the inner cover is made of about forty to forty five folds for the front plate of the body part and about thirty five to forty folds for the rear plate so that larger buoyancy is generated in the chest region of the wearer.

7. The salvage system as claimed in claim 3, wherein the life jacket is attached with a nigh light emitting means.

8. The salvage system as claimed in claim 6, wherein the night light emitting means is a LDP light emitting device and a light emitting tape.
